(19) United States
(12) Patent Application Publication
(10) Pub. No.: US 2004/0257374 A1
(43) Pub. Date: Dec. 23, 2004

(54) Method and apparatus for the efficient representation of block-based images

(76) Inventor: James William McGowan, Whitehouse Station, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/464,727

(22) Filed: Jun. 18, 2003

(51) Int. Cl. G09G 5/36

(52) U.S. Cl. 345/547

(57) ABSTRACT

A method and apparatus for the efficient block-based representation of images and video frames when coded with use of pipelined processors. The pixel data of the image is stored in memory so that the data for a given subblock is contiguous. In particular, the second row of data for the given subblock is stored in the memory “immediately” subsequent to the first row of data for the subblock, the third row of data for the subblock is stored in the memory “immediately” subsequent to the second row of data for the subblock, etc.

### FIELD OF THE INVENTION

The present invention relates generally to the field of image and video compression techniques, and in particular to a method and apparatus for the efficient block-based representation of images and video frames for use in such techniques.

### BACKGROUND OF THE INVENTION

In video compression, video encoding is a major computational bottleneck. The demands of video processing have been a significant driver in the design of processors, computer systems, and communication networks, and will continue to be an increasingly important design specification as video applications, such as real-time video delivered over the Internet, become more common. Some of these applications are particularly demanding of computational resources, and so, to make these applications available to more consumers, very efficient implementations of the encoding algorithms are required.

In fact, compression and decompression of both still images and sequences of video images, either for transport over communications networks such as the Internet or for compact storage (e.g., on DVDs), has been a subject of significant interest for a number of years. For example, in the video domain, a number of compression (also referred to as coding) standards have been defined, such as ITU-T H.263, a recommendation promulgated by the International Telecommunication Union, and MPEG-1, MPEG-2 (the current DVD standard) and MPEG-4, which are standards promulgated by the Moving Picture Experts Group, as well as the widely-anticipated H.264 (also known as MPEG-4 AVC), the newest video compression standard. This latest standard was created in a joint development project between the ITU and ISO (The International Organization for Standardization) bodies, and is expected to replace MPEG-2 as the most widely deployed standard. More efficient designs are required to allow cheaper and smaller systems to handle the computational demands of H.264.

When performing compression of either an image or a “frame” of a video sequence, the pixel (i.e., picture element) data that represents the content of the image is invariably laid out in computer memory essentially as one sees it (or more particularly, as a camera would typically scan it)—left to right (first) and (then) top to bottom, wrapping around from one line to the next one below it, until all lines have been included. That is, the image is stored with consecutive rows of the complete image placed contiguously in memory—with the first row placed in the memory at a selected location (with the pixels in left-to-right order as one might see them by scanning across a screen), the second row placed in the memory immediately following the first row (again, with the pixels in left-to-right order), and so on. In other words, all of the pixel data representing the first line (i.e., row) of the image is first stored sequentially in the memory, followed by all of the pixel data representing the second line of the image (which is stored sequentially in the memory immediately after the first line of data), etc. Of course, this is an obvious and convenient manner in which to store the data, not only because it is natural (e.g., the way we read an English language text), but because cameras have invariably been designed to scan the observed image in this very way, and to produce an output signal data stream which provides the pixel data in this sequence.

On the other hand, note that most codecs (i.e., coding/decoding algorithms) do not typically process the pixel data in this “obvious” sequence. Rather, codecs which implement modern image or video coding algorithms are almost always block-based in that they conceptually divide an image into square or rectangular subblocks—most typically square ones of, for example, 8-by-8 or 16-by-16 pixels each—and then, they process (e.g., code) each of these blocks individually. (The terms “block” and “subblock” will be used interchangeably herein.) Traditionally, this has not resulted in any particular difficulty or inefficiency, since the pixel data is invariably stored in RAM (random access memory), from which the data may be easily and conveniently retrieved in any desired order whatsoever without any particular (or significant) loss of efficiency.

### SUMMARY OF THE INVENTION

The present inventor recognized that the use of an alternative organization of the data representation of an image or a video frame will advantageously result in a significantly more efficient coding process when modern “high-end” processors are used in implementing the codec. In particular, note that many modern processors are specifically optimized for the sequential processing of data contained in consecutive memory locations. (Such processors are typically referred to as “pipelined” processors.)

More specifically, each instruction of these pipelined processors performs, in parallel, a fetch, a decode, and an execute—that is, for example, the processor pre-fetches data for a subsequent instruction while decoding and executing a current instruction, essentially making the assumption (for purposes of efficiency) that the data access will more likely than not be sequential. In other words, the processor loads (i.e., pre-fetches) the next sequential item of data in anticipation of its use. When the data access is, in fact, sequential, substantial efficiency gains will result.

Whenever data access in a pipelined processor turns out not to be sequential, however, a “processor stall” occurs. During such a processor stall, the processor waits, without executing any instructions, while the needed data is fetched from memory. Clearly then, the use of such a pipelined architecture causes no erroneous behavior in either case (i.e., even when the data access turns out not to be sequential). However, some efficiency will be lost when such a processor stall occurs. In fact, since memory access times can be substantially longer than the processor's instruction execution speed, processor stalls are best avoided whenever possible, for purposes of maximizing the efficiency (i.e., speed) of execution.

Therefore, the present invention specifically recognizes that the block-based nature of image and video coding algorithms, when used in concert with a traditional layout of pixel data for an image or video frame, results in a highly inefficient use of the capabilities of modern processors with built-in pipelined processing techniques. Note in particular that, when performing a typical block-based operation on, for example, an m-by-m block of pixels in a given image, m processor stalls will likely occur, since at the end of every row the processor stalls as it must “reach ahead” to get the first pixel of the next row of the block.

As such, in accordance with an illustrative embodiment of the present invention, the pixel data of an image is advantageously stored in memory so that the data for a given block is contiguous. In particular, the second row of data for the given block is stored in the memory “immediately” subsequent to the first row of data for the block, the third row of data for the block is stored in the memory “immediately” subsequent to the second row of data for the block, etc. (As used in the specification and claims herein, a second set of pixel data is said to be stored “immediately” subsequent to a first set of pixel data whenever no pixel data representative of any portions of the image other than those represented by the first and second sets of pixels are stored in between the first and second sets of pixel data. In other words, the phrase “immediately subsequent to,” as used herein when applied to the storage of pixel data in a memory, represents the proximate storage of the pixel data only relative to the storage of other corresponding pixel data for other portions of the image.)

In other words, the pixel data representative of the rows of each block are stored sequentially, thereby resulting in all of the data for the given block being stored together in a contiguous portion of the memory (e.g., in contiguous memory locations). Then, only after all of the data for the given block has been stored in a contiguous portion of the memory will data associated with the next block be stored.

### BRIEF DESCRIPTION OF THE DRAWINGS

FIG. 1 shows a portion of an illustrative 128-by-128 image as it might be stored in a memory in accordance with a prior art approach.

FIG. 2 shows a portion of an illustrative 128-by-128 image as it is stored in a memory in accordance with an illustrative embodiment of the present invention.

FIG. 3 shows a flowchart of a method of generating a data structure representing an image for storage in a memory in accordance with an illustrative embodiment of the present invention.

### DETAILED DESCRIPTION

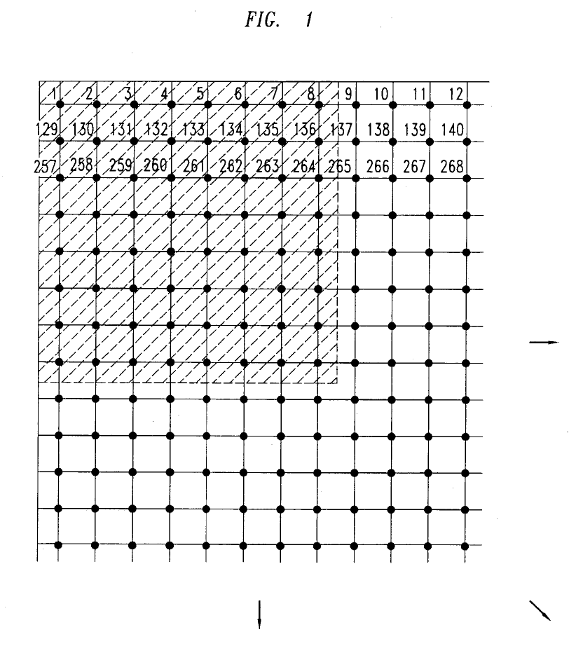

FIG. 1 shows a portion of an illustrative 128-by-128 image as it might be stored in a memory in accordance with a prior art approach. The highlighted area represents a block, which is illustratively 8-by-8 pixels in this case. Pixels for the first three rows of the image are numbered as they would be in a conventional memory layout, beginning with memory location 1 in the upper right, and progressing sequentially to the right. After a complete row of 128 pixels (of which only the first 12 are shown), numbering continues on the next row with 129.

Consider a modern pipelined processor which is able to load 8 pixels of data at once, and which pre-fetches the next sequential set of 8 pixels of data in anticipation of their use as described above. When such a processor performs a typical block-based operation on the illustrative image stored in memory as shown in FIG. 1, it will first load memory locations 1 through 8 into its pipeline, and begin executing instructions on those pixels. Simultaneous with the execution of those instructions however, a separate portion of the chip pipeline will load (i.e., pre-fetch) memory locations 9 through 16 in anticipation of their use. However, in block-based operations, locations 9 through 16 are not in fact used next—rather, locations 129 through 136 are used next. Thus, when the next processing instruction attempts to operate on memory locations 129 through 136, a costly processor stall will occur as the entire processing core must wait for the appropriate locations to be loaded from memory. Note that such a stall will occur as each row of the block is processed, thereby losing much of the efficiency of the pipelined architecture.

By re-arranging the pixel data as stored in the memory, processor stalls can be advantageously avoided for block-based operations in accordance with the principles of the present invention. Note that most operations performed by a typical video (or still image) encoder are block-based, and operations that are not required to operate in a block-based mode can clearly still do so.

Obviously there will be instances where stalls will occur under any possible representation—not all operations performed by video encoders are block-based. The bulk of encoding operations, however, and decoding, however, are motion estimation, discrete cosine (or similar) transforms, and sub-pixel calculations, all of which are familiar to those of ordinary skill in the art are which will benefit from the herein described memory arrangement in accordance with the illustrative embodiment of the present invention.

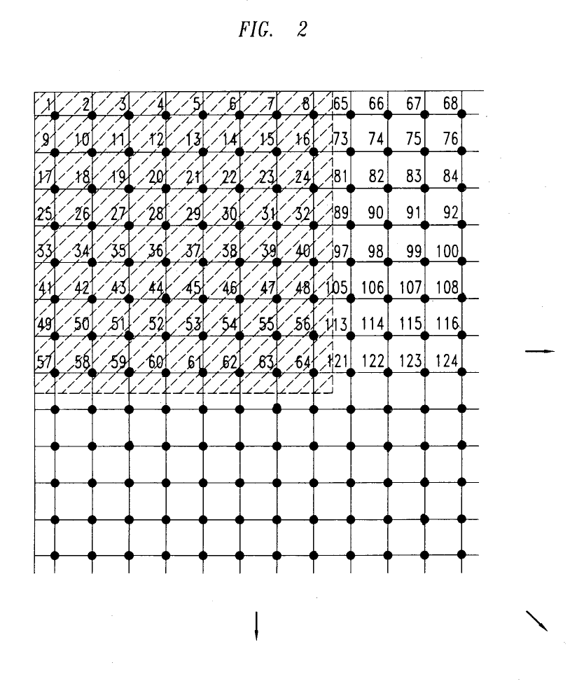

Specifically, FIG. 2 shows a portion of an illustrative 128-by-128 image as it is stored in a memory in accordance with an illustrative embodiment of the present invention. In particular, FIG. 2 shows a “re-numbering” of FIG. 1 which demonstrates the illustrative embodiment of the present invention. This “re-numbering” advantageously places the second row of the highlighted block immediately after the first row of the block, the third row of the block immediately after the second row, and so on. Thus, when a pipelined processor completes its operations on one row of the block, the next row of the block is already loaded into the processor, and advantageously, no processor stall occurs.

In other words, in accordance with the illustrative embodiment of the present invention shown in FIG. 2, all of the pixels in the first block (i.e., the highlighted region) are consecutively numbered (i.e., stored in consecutive memory locations), and would therefore be automatically loaded (i.e., pre-fetched) by the chip in anticipation of their use. Note that the “second” block—the block to the right of the highlighted region—is numbered (e.g., stored in memory) next, allowing thereby also advantageously allowing the processing of the subsequent block without a processor stall as well.

Note that one practical advantage of arranging image pixels in memory in the conventional manner is that programmers can easily calculate the location of an arbitrary single pixel in memory if they know its Cartesian coordinates. For example, if a programmer knows that a pixel of interest is in the fifth column and third row of a 128-by-128 pixel image, the memory location where that pixel is stored is simply 128×3+5=389 in the conventional representation. In the presently described representation of the illustrative embodiment of the present invention, a single inline function may be advantageously employed.

For example, the following lines of pseudo-code (which will be readily understood by one of ordinary skill in the art) advantageously compute a memory offset (i.e., location) of an individual pixel at location (x,y) in the image:

nBlocksX = ImageWidth ./ BlockWidth;
Block = floor(X./BlockWidth) + (floor(Y./BlockWidth) * nBlocksX);
xOffset = rem(X,ImageWidth);
yOffset = rem(Y,BlockHeight) .* ImageSizeX;
pixel_location = Block.*(BlockWidth.*BlockHeight) + xOffset + yOffset;

Although this computation is more complex than the computation required for locating a pixel in the conventional memory layout, it should be noted that this computation (a) is performed infrequently if at all in the course of normal encoding and decoding, and (b) has several terms that are constants for a given image size, and, therefore, which can be precomputed and stored.

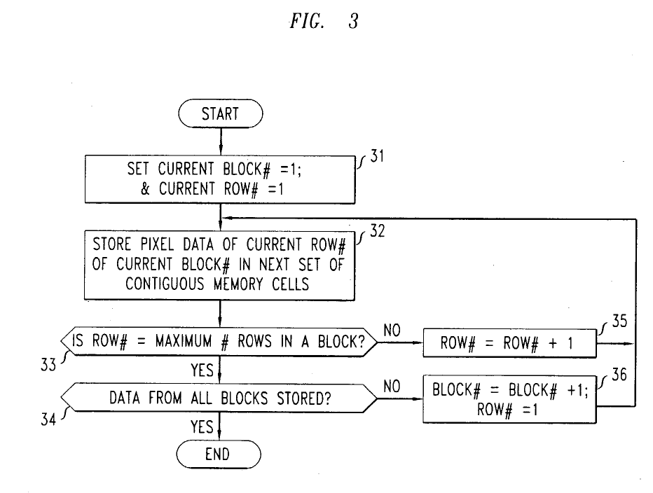

FIG. 3 shows a flowchart of a method of generating a data structure representing an image for storage in a memory in accordance with an illustrative embodiment of the present invention. As shown in the figure, box 31 of the flowchart sets the current block number and the current row number to one (in preparation of storing the first row of the first block). Box 32 of the flowchart stores the pixel data of the current row of the current block in the next set of contiguous memory cells.

Decision box 33 determines whether the current block has been completely stored in the memory—that is, whether the current row number is equal to the maximum number of rows in the block. If not, then box 35 of the flowchart increments the current row number and flow returns to flowchart box 32 to store the pixel data of the next row of the current block. If so, then decision box 34 determines whether the entire image has been stored—that is, whether there are no more blocks to be stored. If so, the procedure is complete. If not, then box 36 of the flowchart increments the current block number and sets the current row number back to one, and then, flow returns to flowchart box 32 to store the pixel data of the first row of the next block.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope.

Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

I claim:

1. A method of generating a data structure for storage in a computer-readable memory having sequentially identifiable memory cell locations, the data structure representative of an image comprising a two-dimensional array of pixels having a plural first number of pixel rows and a plural first number of pixel columns, the two-dimensional array of pixels comprising a plurality of disjoint two-dimensional pixel subblocks, each pixel subblock having a second plural number of pixel rows and a second number of pixel columns, the second number of pixel columns being less than the first number of pixel columns, the method comprising the steps of:
storing a first set of pixel data in a first sequential subset of said memory cell locations of said memory, the first set of pixel data consisting of a row of pixel data from one of said pixel subblocks; and
storing a second set of pixel data in a second sequential subset of said memory cell locations of said memory, the second set of pixel data consisting of a subsequent row of pixel data from said one of said pixel subblocks, said second sequential subset of memory cell locations of said memory comprising memory cell locations immediately subsequent to said first sequential subset of said memory cell locations of said memory.

2. The method of claim 1 wherein substantially all of the pixel data from said one of said pixel subblocks is stored in a contiguous subset of said memory cell locations of said memory.

3. The method of claim 1 wherein the second plural number of pixel rows and the second number of pixel columns are each equal to 8.

4. The method of claim 1 wherein the second plural number of pixel rows and the second number of pixel columns are each equal to 16.

5. A method of generating a data structure for storage in a computer-readable memory having sequentially identifiable memory cell locations, the data structure representative of an image comprising a two-dimensional array of pixels having a plural first number of pixel rows and a plural first number of pixel columns, the two-dimensional array of pixels comprising a plurality of disjoint two-dimensional pixel subblocks, each pixel subblock having a second plural number of pixel rows and a second number of pixel columns, the second number of pixel columns being less than the first number of pixel columns, the method comprising the steps of:
storing a first set of pixel data in a first contiguous subset of said memory cell locations of said memory, the first set of pixel data consisting of substantially all of the pixel data from a first one of said pixel subblocks; and
storing a second set of pixel data in a second contiguous subset of said memory cell locations of said memory, the second set of pixel data consisting of substantially all of the pixel data from a second one of said pixel subblocks.

6. The method of claim 5 wherein the second plural number of pixel rows and the second number of pixel columns are each equal to 8.

7. The method of claim 5 wherein the second plural number of pixel rows and the second number of pixel columns are each equal to 16.

8. A computer-readable memory containing a representation of an image comprising a two-dimensional array of pixels having a plural first number of pixel rows and a plural first number of pixel columns, the two-dimensional array of pixels comprising a plurality of disjoint two-dimensional pixel subblocks, each pixel subblock having a second plural number of pixel rows and a second number of pixel columns, the second number of pixel columns being less than the first number of pixel columns, wherein:
a first set of pixel data has been stored in a first sequential subset of said memory cell locations of said memory, the first set of pixel data consisting of a row of pixel data from one of said pixel subblocks; and
a second set of pixel data has been stored in a second sequential subset of said memory cell locations of said memory, the second set of pixel data consisting of a subsequent row of pixel data from said one of said pixel subblocks, said second sequential subset of memory cell locations of said memory comprising memory cell locations being immediately subsequent to said first sequential subset of said memory cell locations of said memory.

9. The computer-readable memory of claim 8 wherein substantially all of the pixel data from said one of said pixel subblocks has been stored in a contiguous subset of said memory cell locations of said memory.

10. The computer-readable memory of claim 8 wherein the second plural number of pixel rows and the second number of pixel columns are each equal to 8.

11. The computer-readable memory of claim 8 wherein the second plural number of pixel rows and the second number of pixel columns are each equal to 16.

12. A computer-readable memory containing a representation of an image comprising a two-dimensional array of pixels having a plural first number of pixel rows and a plural first number of pixel columns, the two-dimensional array of pixels comprising a plurality of disjoint two-dimensional pixel subblocks, each pixel subblock having a second plural number of pixel rows and a second number of pixel columns, the second number of pixel columns being less than the first number of pixel columns, wherein:
a first set of pixel data has been stored in a first contiguous subset of said memory cell locations of said memory, the first set of pixel data consisting of substantially all of the pixel data from a first one of said pixel subblocks; and
a second set of pixel data has been stored in a second contiguous subset of said memory cell locations of said memory, the second set of pixel data consisting of substantially all of the pixel data from a second one of said pixel subblocks.

13. The computer-readable memory of claim 12 wherein the second plural number of pixel rows and the second number of pixel columns are each equal to 8.

14. The computer-readable memory of claim 12 wherein the second plural number of pixel rows and the second number of pixel columns are each equal to 16.
